(19) United States
(12) Patent Application Publication
(10) Pub. No.: US 2010/0124523 A1
(43) Pub. Date: May 20, 2010

(54) Emissions Treatment Catalysts

(75) Inventors: Shau-Lin F. Chen, Iselin, NJ (US); Tian Luo, Piscataway, NJ (US); Michael P. Galligan, Cranford, NJ (US); Harold Rabinowitz, Montclair, NJ (US)

Correspondence Address: BASF CATALYSTS LLC, 100 CAMPUS DRIVE, FLORHAM PARK, NJ, 07932, US

(73) Assignee: BASF Catalysts LLC, Florham Park, NJ (US)

(21) Appl. No.: 12/621,346

(22) Filed: Nov. 18, 2009

Related U.S. Application Data
(60) Provisional application No. 61/115,958, filed on Nov. 19, 2008.

(51) Int. Cl. B01D 53/94; B01J 23/10

(52) U.S. Cl. 423/213.5; 502/303

(57) ABSTRACT

An emissions treatment catalyst formed using pH-compatible ingredients is disclosed. Engine exhaust treatment systems including such catalysts are also provided. Methods of making and using these catalysts are also provided. Methods include creating precious metal-support composites where the precious metal precursor has a solution pH that is compatible an aqueous slurry pH of the support. In one example, a basic precious metal solution having a pH of 7 or greater is mixed with a promoted refractory metal oxide support having an aqueous slurry pH of 7 or greater. On the other hand, an acidic precious metal solution having a pH of less than 7 is mixed with a promoted refractory metal oxide support having an aqueous slurry pH of less than 7. The mixture of the salt and the promoted refractory metal oxide support can be thermally treated at a temperature of at least 180° C. to thermally fix the well-dispersed precious metal on the support. Complex ions of basic solutions and include tetraamine nitrate, tetraamine hydroxide, tetraamine acetate, a primary amine nitrate, a primary amine hydroxide, a primary amine acetate, or combinations thereof. The refractory metal oxide support can be promoted by oxides of lanthanum, barium, zirconium, neodymium, yttrium, praseodymium, somarium, ceria, or combinations thereof.

### BENEFIT OF EARLIER FILED PROVISIONAL PATENT APPLICATION

This patent application claims priority under 35 USC §119 (e) to pending provisional patent application Ser. No. 61/115,958 filed Nov. 19, 2008 incorporated herein by reference in its entirety.

### TECHNICAL FIELD

This invention pertains generally to emissions treatment catalysts used to treat gaseous steams containing hydrocarbons, carbon monoxide, and oxides of nitrogen. More specifically, this invention is directed to three-way conversion (TWC) catalysts and/or diesel oxidation catalysts (DOC) having platinum and palladium on promoted supports.

### BACKGROUND

Catalytic converters containing a TWC catalyst are located in the exhaust gas line of internal combustion engines. Such catalysts promote the oxidation by oxygen in the exhaust gas stream of unburned hydrocarbons and carbon monoxide as well as the reduction of nitrogen oxides to nitrogen. Catalytic converters can alternatively contain a diesel oxidation catalyst. Such a catalyst promotes the oxidation by oxygen in the exhaust gas stream of unburned hydrocarbons and carbon monoxide.

Known TWC and DOC catalysts that exhibit good activity and long life comprise one or more platinum group metals (e.g., platinum, palladium, rhodium, rhenium and iridium) disposed on a high surface area, refractory metal oxide support, e.g., a high surface area alumina coating. The support is carried on a suitable carrier or substrate such as a monolithic carrier comprising a refractory ceramic or metal honeycomb structure, or refractory particles such as spheres or short, extruded segments of a suitable refractory material. TWC catalysts and DOCs can be manufactured in many ways.

In WO 2005/077497 (Wolf), provided is an exhaust gas cleaning catalyst with an axially varying precious metal concentration. Wolf provides examples of palladium components for use with washcoats, where a suitable poorly adsorbing precursor compound is palladium tetraamine nitrate and a suitable strongly adsorbing precursor compound is palladium nitrate.

It is a continuing goal to develop three-way conversion (TWC) catalyst systems and DOC systems. There is also a goal to utilize components of such catalysts, for example, palladium, as efficiently as possible.

### SUMMARY

Provided are catalytic materials that provide excellent precious metal dispersion, stability, and durability, leading to excellent catalytic activity. One or more methods provide that solutions of precious metals are pH compatible with aqueous solutions of promoted supports during preparation of washcoat slurries. One or more further methods include thermal treatment of washcoat slurries to fix the precious metal on the support.

In an aspect, methods of making an emissions treatment catalyst are provided, the methods comprising: providing a solution of a salt of a precious metal having a pH; providing a promoted refractory metal oxide support having an aqueous slurry pH that is compatible with the pH of the solution of the salt of the precious metal; impregnating the solution of the salt of the precious metal onto the promoted refractory metal oxide support to well disperse the precious metal and to form a wetted powder; forming a washcoat slurry by mixing the wetted powder with water and other components such as OSC, peptizing agents such as an acid or base, and binder; coating a carrier with the washcoat slurry to form a layer; and drying and calcining the layer to form the emissions treatment catalyst. The methods can further comprise thermal treating the wetted powder in an oven set at a temperature of at least 180° C. to thereby thermally fix the precious metal on the promoted support to form a supported precious metal composite.

Provided in another aspect are catalyst composites for three-way conversion or diesel oxidation, the catalyst composite comprising: a layer of catalytic material on a carrier, the catalytic material comprising a precious metal component on a promoted refractory metal oxide support, the support comprising one or more promoters, wherein a precursor of the precious metal component has a solution pH that is compatible with an aqueous slurry pH of the support, the precious metal is well-dispersed to provide intimate contact among the precious metal component and the one or more promoters. In a detailed embodiment, the precious metal component has a particle size of no more than 50 Å under fresh conditions or at calcination at a temperature of 530° C. or less. In another embodiment, the precious metal component and the promoted support are thermally treated to form a supported precious metal composite

Also provided are emissions treatment systems comprising an engine and a housing containing a catalytic material on a carrier, the catalytic material comprising a first layer located under an outer layer, the first layer comprising a precious metal component selected from a rhodium component and an optional platinum component on a support, the outer layer comprises a precious metal component selected from a palladium component and an optional platinum component on a support promoted by oxides of lanthanum, barium, zirconium, neodymium, or combinations thereof, wherein the palladium component in the outer layer is formed by the use of thermally treated powders of a basic palladium solution formed from a complex ion comprising tetraamine nitrate, tetraamine hydroxide, tetraamine acetate, or combinations thereof.

Further aspects include methods of treating an emissions stream from an engine, the methods comprising contacting the emissions stream with a catalytic material on a carrier, the catalytic material comprising a first layer located under an outer layer, the first layer comprising a precious metal component selected from a rhodium component and an optional platinum component on a support, the outer layer comprises a precious metal component selected from a palladium component and an optional platinum component on a support promoted by oxides of lanthanum, barium, zirconium, neodymium, or combinations thereof, wherein the palladium component in the outer layer is formed by the use of thermally treated powders of a basic palladium solution formed from a complex ion comprising tetraamine nitrate, tetraamine hydroxide, tetraamine acetate, or combinations thereof.

### BRIEF DESCRIPTION OF FIGURES

FIG. 1 provides a flow diagram of a method in accordance with an embodiment of the present invention.

FIG. 2 shows mid-bed NOx emissions (g/mile) over the period of FTP testing of a catalyst composition according to the present invention along with a comparison catalyst composition.

### DETAILED DESCRIPTION

Provided are catalytic materials that provide excellent precious metal dispersion, stability, and durability, leading to excellent catalytic activity. These materials are improved over prior art methods that use pH incompatible methods where, for example, nitrate salt solutions of precious metals (having an acidic pH) are used in conjunction with promoted supports that have aqueous slurry pHs that are alkaline (in the 9-11 pH range). Such incompatibility can lead to uncontrollable precipitation and mal-distribution of precious metals in the pore surface of the support.

Provided are exhaust systems and components having a catalytic material where a precious metal has been provided by using a solution of a salt of the precious metal having a pH that is compatible with a pH of an aqueous slurry of a promoted refractory metal oxide support. The resulting pH compatible washcoat can then be thermally treated such that solubility and thereby mobility of the precious metal are limited during slurry preparation, processing, and coating. Reference to a compatible pH means that the pH of the solution of the precious metal salt is sufficiently close to that of the promoted refractory metal oxide support in an aqueous slurry (typically 40% solids slurry) to prevent precipitation of the precious metal on pore mouth of support upon impregnating or mixing. Such methods can be applied to single-layered catalysts or multi-layered catalysts. Washcoat slurries can be formed by using incipient wetness methods for precious metal-containing powders or in the presence of excess liquid for precious metal dilution. When excess liquid is used, the mixture is subsequently dried, using techniques known in the art such as IR lamp, heating plate, and microwaving.

In an aspect, methods of making an emissions treatment catalyst are provided, the methods comprising: providing a solution of a salt of a precious metal having a pH; providing a promoted refractory metal oxide support having an aqueous slurry pH that is compatible with the pH of the solution of the salt of the precious metal; impregnating the solution of the salt of the precious metal onto the promoted refractory metal oxide support to well disperse the precious metal and to form a wetted powder; forming a washcoat slurry by mixing the wetted powder with water and a peptizing agent, and a binder; coating a carrier with the washcoat slurry to form a layer; and drying and calcining the layer to form the emissions treatment catalyst. Reference to a peptizing agent means a material that enhances dispersion of materials in the washcoat slurry. Examples of peptizing agents include an acid or base.

The methods can further comprise thermal treating the wetted powder in an oven set at a temperature of at least 180° C. to thereby thermally fix the precious metal on the promoted support to form a supported precious metal composite. Reference to thermally treating means that a washcoat slurry is heated under conditions that decompose the precious metal salt to form the precious metal oxide. Generally, this can occur in an oven set at a temperature of at least 180° C. for about 1 hour. Specific conditions include an oven temperature in the range of 350° C. to 550° C.

Provided in another aspect, are catalyst composites for three-way conversion or diesel oxidation, the catalyst composite comprising: a layer of catalytic material on a carrier, the catalytic material comprising a precious metal component on a promoted refractory metal oxide support, the support comprising one or more promoters, wherein a precursor of the precious metal component has a solution pH that is compatible with an aqueous slurry pH of the support, the precious metal is well-dispersed to provide intimate contact among the precious metal component and the one or more promoters. In a detailed embodiment, the precious metal component has a particle size of no more than 50 Å under fresh conditions or at calcination at a temperature of 530° C. or less.

Reference to fresh conditions means that the condition of the catalyst after manufacture and before exposure to high temperature >700° C. aging conditions. Promoters can include oxides of lanthanum, barium, zirconium, neodymium, ceria, yttrium, praseodymium, somarium, ceria, or combinations thereof. Basic supports can include alumina-zirconia, lanthana-alumina, lanthana-zirconia-alumina, baria-alumina, baria-lanthana-alumina, baria-lanthana-neodymia-alumina, lanthana-neodymia-alumina, and alumina-ceria. Basic salts can include an amine nitrate, such as tetraamine nitrate, tetraamine hydroxide, and tetraamine acetate. Primary amines can also be used as ligands for precious metal salts or complexes. Acidic supports can include alumina with silica, titania, or combinations thereof. Acidic salts can include nitrates and/or acetates.

Also provided are emissions treatment systems comprising an engine and a housing containing a catalytic material on a carrier, the catalytic material comprising a first layer located under an outer layer, the first layer comprising a precious metal component selected from a rhodium component and an optional platinum component on a support, the outer layer comprises a precious metal component selected from a palladium component and an optional platinum component on a support promoted by oxides of lanthanum, barium, zirconium, neodymium, or combinations thereof, wherein the palladium component in the outer layer is formed by the use of thermally treated powders of a basic palladium solution formed from a complex ion comprising tetraamine nitrate, tetraamine hydroxide, tetraamine acetate, or combinations thereof.

Further aspects include methods of treating an emissions stream from an engine, the methods comprising contacting the emissions stream with a catalytic material on a carrier, the catalytic material comprising a first layer located under an outer layer, the first layer comprising a precious metal component selected from a rhodium component and an optional platinum component on a support, the outer layer comprises a precious metal component selected from a palladium component and an optional platinum component on a support promoted by oxides of lanthanum, barium, zirconium, neodymium, or combinations thereof, wherein the palladium component in the outer layer is formed by the use of thermally treated powders of a basic palladium solution formed from a complex ion comprising tetraamine nitrate, tetraamine hydroxide, tetraamine acetate, or combinations thereof.

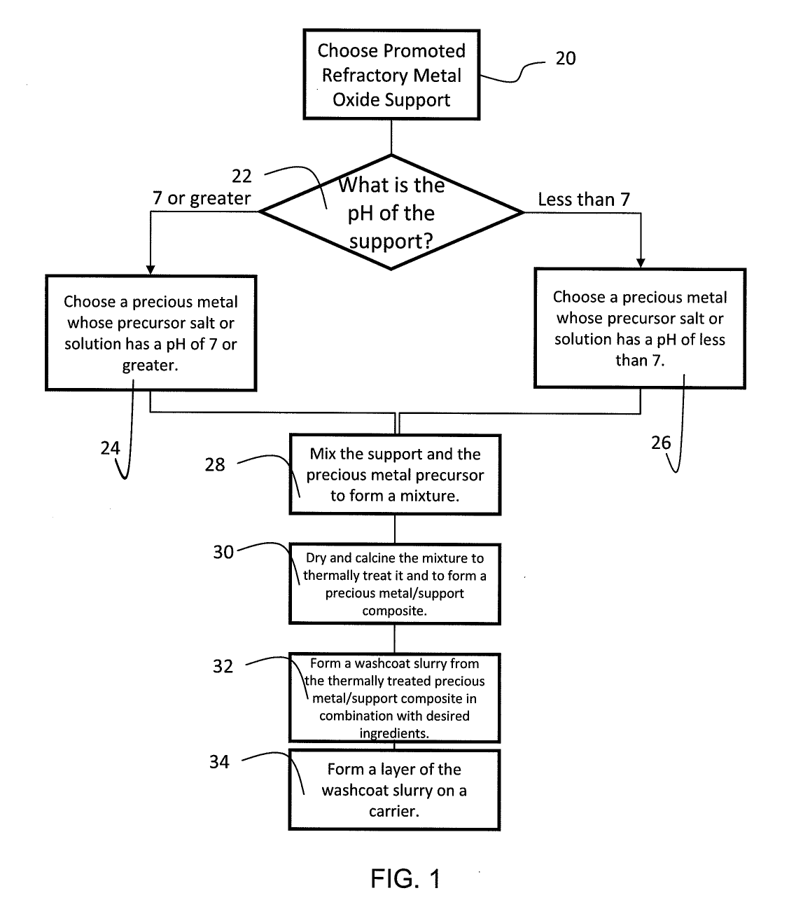

In FIG. 1, a flow diagram of a method according to the present invention is provided. A promoted refractory metal oxide support is selected 20 based on various factors such as hydrothermal stability, poison resistance, and/or customer requirements. Determination of the pH of the support is then made 22. If the pH is 7 or greater, then a precious metal precursor having a pH of 7 or greater is chosen 24. If the pH is less than 7, then a precious metal precursor having a pH of less than 7 is chosen 26. The support and the precious metal precursor are then mixed 28 to form a wetted powder. That is, the precious metal is impregnated onto the support either by incipient wetness or with excessive wetting. The wetted powder is then thermally treated 30. Specifically, the wetted powder is dried, as needed (IR and oven drying) and then calcined. Calcination of the powder is normally performed above 180° C. to decompose the precious metal complex to precious metal oxides and to form a precious metal/support composite. A washcoat slurry is then formed 32 according to methods known in the art by mixing the composite with desired ingredients, such as acid, OSC and binders. A layer of the washcoat slurry is formed on a carrier 34 by coating the slurry onto the carrier.

Reference to a “support” in a catalyst layer refers to a material onto or into which precious metals, stabilizers, promoters, binders, and the like are dispersed, impregnated or adhered to, respectively. A support can be activated and/or stabilized as desired. Examples of supports include, but are not limited to, high surface area refractory metal oxides and composites containing oxygen storage components. One or more embodiments of the present invention include a high surface area refractory metal oxide support comprising an activated compound selected from the group consisting of alumina, silica, silica-alumina, alumino-silicates, alumina-zirconia, lanthana-alumina, lanthana-zirconia-alumina, baria-alumina, baria-lanthana-alumina, baria-lanthana-neodymia-alumina, lanthana-neodymia-alumina, and alumina-ceria. Examples of composites containing oxygen storage components include, but are not limited to, ceria-zirconia, ceria-zirconia-lanthana, ceria-zirconia-lanthana-yttria, ceria-zirconia-lanthana-neodymia, ceria-zirconia-lanthana-praseodymia, and ceria-zirconia-neodimia-praseodymia. Reference to a “ceria-zirconia composite” means a composite comprising ceria and zirconia, without specifying the amount of either component. Suitable ceria-zirconia composites include, but are not limited to, composites having, for example, 5%, 10%, 15%, 20%, 25%, 30%, 35%, 40%, 45%, 50%, 55%, 60%, 65%, 70%, 75%, 80%, 85%, 90% or even 95% of ceria content. Certain embodiments provide that the support comprises bulk ceria having a nominal ceria content of 100% (i.e., >99% purity).

High surface area refractory metal oxide supports, e.g., alumina support materials, also referred to as “gamma alumina” or “activated alumina,” typically exhibit a BET surface area in excess of 60 square meters per gram (“m²/g”), often up to about 300 m²/g or higher. Such activated alumina is usually a mixture of the gamma and delta phases of alumina, but may also contain substantial amounts of eta, kappa and theta alumina phases. Refractory metal oxides other than activated alumina can be used as a support for at least some of the catalytic components in a given catalyst. For example, bulk ceria, zirconia, alpha alumina and other materials are known for such use. Although many of these materials suffer from the disadvantage of having a considerably lower BET surface area than activated alumina, that disadvantage tends to be offset by a greater durability of the resulting catalyst. “BET surface area” has its usual meaning of referring to the Brunauer, Emmett, Teller method for determining surface area by N₂ adsorption.

### Catalyst Carriers

According to one or more embodiments, the carrier may be any of those materials typically used for preparing TWC and/or diesel catalysts and will preferably comprise a metal or ceramic honeycomb structure. Any suitable carrier may be employed, such as a monolithic carrier of the type having a plurality of fine, parallel gas flow passages extending therethrough from an inlet or an outlet face of the carrier, such that passages are open to fluid flow therethrough. The passages, which are essentially straight paths from their fluid inlet to their fluid outlet, are defined by walls on which the catalytic material is coated as a “washcoat” so that the gases flowing through the passages contact the catalytic material. The flow passages of the monolithic carrier are thin-walled channels which can be of any suitable cross-sectional shape and size such as trapezoidal, rectangular, square, sinusoidal, hexagonal, oval, circular, etc. Such structures may contain from about 60 to about 900 or more gas inlet openings (i.e., “cells”) per square inch of cross section.

The ceramic carrier may be made of any suitable refractory material, e.g., cordierite, cordierite-α alumina, silicon nitride, zircon mullite, spodumene, alumina-silica magnesia, zircon silicate, sillimanite, magnesium silicates, zircon, petalite, α-alumina, aluminosilicates and the like.

The carriers useful for the catalyst composites of the present invention may also be metallic in nature and be composed of one or more metals or metal alloys. The metallic carriers may be employed in various shapes such as corrugated sheet or monolithic form. Preferred metallic supports include the heat resistant metals and metal alloys such as titanium and stainless steel as well as other alloys in which iron is a substantial or major component. Such alloys may contain one or more of nickel, chromium and/or aluminum, and the total amount of these metals may advantageously comprise at least 15 wt. % of the alloy, e.g., 10-25 wt. % of chromium, 3-8 wt. % of aluminum and up to 20 wt. % of nickel. The alloys may also contain small or trace amounts of one or more other metals such as manganese, copper, vanadium, titanium and the like. The surface or the metal carriers may be oxidized at high temperatures, e.g., 900° C. and higher, to improve the corrosion resistance of the alloy by forming an oxide layer on the surface the carrier. Such high temperature-induced oxidation may enhance the adherence of the refractor) metal oxide support and catalytically-promoting metal components to the carrier.

### Preparation of the Catalyst Composite

When catalyst materials, according to the present invention, are combined with other layers, these other layers may be readily prepared by processes well known in the prior art, see for example U.S. Patent Publication No. 2004/0001782, incorporated herein by reference in its entirety. A representative detailed process for making the other layers of catalytic material is set forth below. As used herein, the term “washcoat” has its usual meaning in the art of a thin, adherent coating of a catalytic or other material applied to a substrate carrier material, such as a honeycomb-type carrier member, which is sufficiently porous to permit the passage there through of the gas stream being treated.

For a first layer of a specific washcoat, finely divided particles of a high surface area refractory metal oxide such as gamma alumina are slurried in an appropriate vehicle, e.g., water. The carrier may then be dipped one or more times in such slurry or the slurry may be coated on the carrier such that there will be deposited on the carrier the desired loading of the metal oxide, e.g., about 0.5 to about 2.5 g/in³. To incorporate components such as precious metals (e.g., palladium, rhodium, platinum, and/or combinations of the same), stabilizers and/or promoters, such components may be incorporated in the slurry as a mixture of water soluble or water-dispersible compounds or complexes. Thereafter, the coated carrier is calcined by heating, e.g., at 450-600° C. for about 1 to about 3 hours. Typically, when palladium is desired, the palladium component is utilized in the form of a compound or complex to achieve dispersion of the component on the refractory metal oxide support, e.g., activated alumina. For the purposes of the present invention, the term “palladium component” means any compound, complex, or the like which, upon calcination or use thereof, decomposes or otherwise converts to a catalytically active form, usually the metal or the metal oxide. Water-soluble compounds or water-dispersible compounds or complexes of the metal component may be used as long as the liquid medium used to impregnate or deposit the metal component onto the refractory metal oxide support particles does not adversely react with the metal or its compound or its complex or other components which may be present in the catalyst composition and is capable of being removed from the metal component by volatilization or decomposition upon heating and/or application of a vacuum. In some cases, the completion of removal of the liquid may not take place until the catalyst is placed into use and subjected to the high temperatures encountered during operation. Generally, both from the point of view of economics and environmental aspects, aqueous solutions of soluble compounds or complexes of the precious metals are utilized. For example, suitable compounds are palladium nitrate or rhodium nitrate. During the calcination step, or at least during the initial phase of use of the composite, such compounds are converted into a catalytically active form of the metal or a compound thereof.

A suitable method of preparing other layers of the catalyst composite of the invention is to prepare a mixture of solution of at least one desired precious metal compound (e.g., palladium compound, or palladium and platinum compounds) and at least one finely divided, high surface area, refractory metal oxide support, e.g., gamma alumina, which is sufficiently dry to absorb substantially all of the solution to form a wet solid which later combined with water to form a coatable slurry. In one or more embodiments, the slurry is acidic, having a pH of about 2 to less than about 7. The pH of the slurry may be lowered by the addition of an adequate amount of an inorganic or an organic acid to the slurry. Combination of both can be used when compatibility of acid and raw materials is considered. Inorganic acids include, but are not limited to, nitric acid. Organic acids include, but are not limited to, acetic, propionic, oxalic, malonic, succinic, glutamic, adipic, maleic, fumaric, phthalic, tartaric, citric acid and the like. Thereafter, if desired, water-soluble or water-dispersible compounds of oxygen storage components, e.g., cerium-zirconium composite, a stabilizer, e.g., barium acetate or nitrate, and a promoter, e.g., lanthanum acetate or nitrate, may be added to the slurry.

In one embodiment, the slurry is thereafter comminuted to result in substantially all of the solids having particle sizes of less than about 20 microns, i.e., between about 0.1-15 microns, in an average diameter. The communication may be accomplished in a ball mill or other similar equipment, and the solids content of the slurry may be, e.g., about 15-60 wt. %, more particularly about 25-40 wt. %.

Additional layers may be prepared and deposited upon the first layer in the same manner as described above for deposition of the first layer upon the carrier.

The catalytic layers may also contain stabilizers and promoters, as desired. Suitable stabilizers include one or more non-reducible metal oxides wherein the metal is selected from the group consisting of barium, calcium, magnesium, strontium, lanthanum, and mixtures thereof. Preferably, the stabilizer comprises one or more oxides of barium and/or strontium. Suitable promoters include one or more non-reducible oxides of one or more rare earth metals selected from the group consisting of lanthanum, barium, zirconium, neodymium, praseodymium, yttrium, somarium, and mixtures thereof.

A catalytic layer may also contain an oxygen storage component. Reference to OSC (oxygen storage component) refers to an entity that has multi-valence state and can actively react with oxidants such as oxygen or nitrous oxides under oxidative conditions, or reacts with reductants such as carbon monoxide (CO) or hydrogen under reduction conditions. Typically, the oxygen storage component will comprise one or more reducible oxides of one or more rare earth metals. Examples of suitable oxygen storage components include ceria. Praseodymia can also be included as an OSC or a promoter. Delivery of an OSC to the layer can be achieved by the use of, for example, mixed oxides composite. For example, ceria can be delivered by a mixed oxide of cerium and zirconium, and/or a mixed oxide of cerium, zirconium, and neodymium. For example, praseodymia can be delivered by a mixed oxide of praseodymium and zirconium, and/or a mixed oxide of praseodymium, cerium, lanthanum, yttrium, zirconium, and neodymium.

Unless otherwise indicated, all numbers expressing quantities of ingredients, reaction conditions, and so forth used in the specification and claims are to be understood as being modified in all instances by the term “about.”

Before describing several exemplary embodiments of the invention, it is to be understood that the invention is not limited to the details of construction or process steps set forth in the following description. The invention is capable of other embodiments and of being practiced in various ways. In the following, preferred embodiments are provided, that can be used alone or in unlimited combination as desired. Other aspects of the invention include methods that utilize such systems. Thus, additional embodiments include methods that utilize such systems and the combinations recited below. Preferred embodiments include:

thermal treating the wetted powder in an oven set at a temperature of at least 180° C. to thereby thermally fix the precious metal on the promoted support to form a supported precious metal composite;

the oven is set at a temperature in the range of 350° C. to 550° C.;

the solution of the salt comprises a neutral or basic solution having a pH of 7 or greater, and thereby the promoted refractory metal oxide has an aqueous slurry pH of 7 or greater, or the solution of the salt comprises an acidic salt having a pH of less than 7, and thereby the promoted refractory metal oxide has an aqueous pH of less than 7;

the impregnating step comprises using an incipient wetness method to well disperse the precious metal onto the support, or the impregnating step comprises using excess solution of the salt;

the washcoat slurry forms a layer that resides on top of one or more layers that are located on a carrier;

the precious metal is selected from the group consisting of palladium, platinum, and rhodium;

the neutral or basic solution comprises a precious metal complex ion comprising an amine-based ligand with an anion selected from the group consisting of nitrate, hydroxide, and acetate;

the amine-based ligand comprises a primary amine, a tetraamine, or both;

the promoted refractory metal oxide comprises alumina that has been promoted with one or more alkaline earth oxides, one or more rare earth oxides, or both;

the refractory metal oxide support has been promoted by oxides of lanthanum, barium, zirconium, neodymium, praseodymium, somarium, or combinations thereof;

the solution comprises palladium tetraamine nitrate and optionally platinum tetraamine nitrate, and the promoted refractory metal oxide comprises baria-lanthana-alumina, or the solution comprises palladium nitrate and optionally platinum nitrate, and the promoted refractory metal oxide comprises silica-alumina, silica-zirconia, silica-titania, zirconia-alumina, zirconia-titania, titania alumia, silica-zirconia alumina, silica-zirconia-titania, silica titania alumina, or combinations thereof;

the catalyst composite comprises: a layer of catalytic material on a carrier, the catalytic material comprising a precious metal component on a promoted refractory metal oxide support, the support comprising one or more promoters, wherein a precursor of the precious metal component has a solution pH that is compatible with an aqueous slurry pH of the support, the precious metal component is well-dispersed to provide intimate contact among the precious metal component and one or more promoters;

the precious metal component has a particle size of no more than 50 Å under fresh conditions or at calcination at a temperature of 530° C. or less;

the precious metal component and the promoted support are thermally treated to form a supported precious metal composite;

the refractory metal oxide support has an average pore radius of at least 45 Å;

the refractory metal oxide support has an average pore radius of at least 70 Å;

the refractory metal oxide support has a BET surface area in the range of 140-190 m²/g.

the catalytic material comprises a first layer located under an outer layer, the first layer comprising a precious metal component selected from a rhodium component and optionally a platinum on a support, and wherein the outer layer comprises a precious metal component selected from a palladium component and optionally a platinum component, wherein the palladium component and the optional platinum component in the outer layer are formed by the use of at least one basic precious metal solution formed from a complex ion comprising tetraamine nitrate, tetraamine hydroxide, tetraamine acetate, a primary amine nitrate, a primary amine hydroxide, a primary amine acetate, or combinations thereof;

the catalytic material is more thermally stable as compared to a comparative catalytic material having a palladium component in an outer layer that is not dispersed to provide intimate contact among the palladium component and the one or more promoters;

formation of a palladium-rhodium alloy in the first layer is reduced compared to a comparative catalytic material where a palladium component in an outer layer is not dispersed or thermally fixed to reduce palladium migration onto inner layers during outer slurry coating; and

the catalytic material further comprising an undercoat layer on the carrier and below the first layer, wherein the undercoat layer comprises a lanthana-promoted alumina support, a first ceria-zirconia composite, and palladium; wherein the first layer further comprises a lanthana-zirconia promoted alumina support and a second ceria-zirconia composite; and wherein the outer layer comprises a lanthana-neodymia-promoted alumina and a third ceria-zirconia support.

### EXAMPLES

The following non-limiting examples shall serve to illustrate the various embodiments of the present invention. One or more comparative examples are also included. In each of the examples, the carrier was cordierite. Reference to a first coat and a second coat provides no limitation on the location or orientation of the coat.

### Example 1A

A catalyst composite having a catalytic material was prepared using three layers: an inner layer, a middle layer, and an outer layer. The layered catalyst composite contained palladium and rhodium with a total precious metal loading of 85 g/ft³ and with a Pd/Rh ratio of 7.5/1. The substrate had a volume of 60.1 in³ (1.0 L), a cell density of 400 cells per square inch, and a wall thickness of approximately 100 μm (4 mil). The layers were prepared as follows:

### Inner Layer

The components present in the inner layer were high surface area lanthanum-stabilized gamma alumina, a ceria-zirconia composite with 30% by weight ceria content, palladium, lanthanum oxide, strontium oxide, barium oxide, zirconium oxide, and an alumina binder, at concentrations of approximately 32.3%, 53.9%, 0.9%, 2.7%, 2.7%, 2.7%, 2.7, and 2.1%, respectively, based on the calcined weight of the catalyst. The total loading of the inner layer was 1.9 g/in³.

Palladium in the form of a palladium nitrate solution was impregnated by planetary mixer (P-mixer) onto the stabilized alumina to form a wet powder while achieving incipient wetness. An aqueous slurry was formed by combining water with all of the above components in solid or soluble salt forms, and milling to particle size of 90% less than 11 microns. The slurry was coated onto a cordierite carrier using deposition methods known in the art for depositing the catalyst on a cordierite substrate. After coating, the carrier plus the inner layer were dried and then calcined at a temperature of 550° C. for about 1 hour.

### Middle Layer

The components present in the middle layer were a high surface stabilized area lanthanum-zirconium-gamma alumina, a ceria-zirconia composite with 36% by weight ceria content, rhodium, zirconium oxide, and an alumina binder, at concentrations of approximately 38.4%, 57.5%, 0.4%, 0.6%, and 3.1%, respectively, based on the calcined weight of the catalyst. The total loading of the middle layer was 1.6 g/in³.

Rhodium in the form of a rhodium nitrate solution was impregnated onto the stabilized gamma alumina by planetary mixer (P-mixer) to form a wet powder while achieving incipient wetness. An aqueous slurry was then formed, using an acid to reduce the pH to <4.5. The slurry was milled to a particle size of 90% less than 12 microns. The slurry was coated onto the cordierite carrier over the inner layer using deposition methods known in the art for depositing the catalyst on a cordierite substrate. After coating, the carrier plus the inner and middle layers were dried, and then calcined at a temperature of 450° C. for about 1 hour.

### Outer Layer

The components present in the outer layer were a lanthanum-neodymium promoted high surface area gamma alumina; a ceria-zirconia composite with 36% by weight ceria content, palladium, barium oxide, zirconium oxide, and a binder, at concentrations of approximately 67.0%, 21.0%, 2.3%, 4.7%, 1.7%, and 3.3%, respectively, based on the calcined weight of the catalyst. The total loading of the outer layer was 1.2 g/in³.

Palladium in the form of palladium-tetraamine-nitrate solutions were impregnated onto the ceria-zirconia composite and the above-identified gamma alumina by planetary mixer (P-mixer) to form a wet powder while achieving incipient wetness as follows. An amount of 10% of the palladium was diluted and impregnated onto the ceria-zirconia composite, while the remainder amount of 90% of the palladium was diluted and impregnated onto the gamma alumina. An aqueous slurry was then formed by combining all ingredients, followed by using an acid to reduce the pH to <4.5. The slurry was milled to a particle size of 90% less than 12 microns. The slurry was coated onto the cordierite carrier over the inner layer using deposition methods known in the art for depositing the catalyst on a cordierite substrate. After coating, the carrier plus the inner and middle layers were dried, and then calcined at a temperature of 550° C. for about 1 hour.

### Example 1B

A catalyst composite having a catalytic material was prepared using three layers: an inner layer, a middle layer, and an outer layer. The layered catalyst composite contained palladium and rhodium with a total precious metal loading of 104 g/ft³ and with a Pd/Rh ratio of 96/8. The substrate had a volume of 42.5 in³ (0.7 L), a cell density of 600 cells per square inch, and a wall thickness of approximately 100 μm (4 mil). The layers were prepared as follows:

### Inner Layer

The components present in the inner layer were high surface area stabilized barium-lanthanum-neodymium-gamma alumina, a ceria-zirconia composite with 30% by weight ceria content, palladium, zirconium oxide, and an alumina binder, at concentrations of approximately 36.9%, 56.8%, 1.2%, 2.8%, and 2.3%, respectively, based on the calcined weight of the catalyst. The total loading of the inner layer was 1.8 g/in³.

Palladium in the form of a palladium-tetraamine-nitrate solution was impregnated by planetary mixer (P-mixer) onto the stabilized alumina and ceria/zirconia composite with 90/10 ratio as in Example 1A, to form wet powders while achieving incipient wetness. After the impregnation of the precious metal onto the support, the mixture was calcined for 4 hours at 550° C. to form a precious meal/support composite. This composite was then mixed with the remaining ingredients to form an aqueous washcoat slurry, which was milled to a particle size of 90% less than 11 microns. The slurry was coated onto a cordierite carrier using deposition methods known in the art for depositing the catalyst on a cordierite substrate. After coating, the carrier plus the inner layer were dried and then calcined at a temperature of 550° C. for about 1 hour.

### Middle Layer

The components present in the middle layer were a high surface stabilized area lanthanum-zirconium-gamma alumina, a ceria-zirconia composite with 36% by weight ceria content, rhodium, zirconium oxide, and a binder, at concentrations of approximately 30.3%, 64.9%, 0.4%, 0.9, and 3.5%, respectively, based on the calcined weight of the catalyst. The total loading of the middle layer was 1.2 g/in³.

Rhodium in the form of a rhodium nitrate solution was impregnated onto the stabilized gamma alumina by planetary mixer (P-mixer) to form a wet powder while achieving incipient wetness. An aqueous slurry was then formed, using an acid to reduce the pH to <4.5. The slurry was milled to a particle size of 90% less than 12 microns. The slurry was coated onto the cordierite carrier over the inner layer using deposition methods known in the art for depositing the catalyst on a cordierite substrate. After coating, the carrier plus the inner and middle layers were dried, and then calcined at a temperature of 550° C. for about 1 hour.

### Outer Layer

The components present in the outer layer were a barium-lanthanum-neodymium promoted high surface area gamma alumina; a ceria-zirconia composite with 36% by weight ceria content, palladium, zirconium oxide, and a binder, at concentrations of approximately 72.1%, 20.6%, 2.4%, 2.1%, and 2.7%, respectively, based on the calcined weight of the catalyst. The total loading of the outer layer was 1.5 g/in³.

Palladium in the form of palladium-tetraamine-nitrate solutions was impregnated onto the ceria-zirconia composite and the above-identified gamma alumina by planetary mixer (P-mixer) to form a wet powder while achieving incipient wetness as follows. An amount of 10% of the palladium was impregnated onto the ceria-zirconia composite and an amount of 90% of the palladium was impregnated onto the gamma alumina. After the impregnation of the precious metal onto the support, the mixture was calcined for 4 hours at 550° C. to form a precious meal/support composite. This composite was then mixed with the remaining ingredients to form an aqueous slurry, using an acid to reduce the pH to <4.5. The slurry was milled to a particle size of 90% less than 12 microns. The slurry was coated onto the cordierite carrier over the inner layer using deposition methods known in the art for depositing the catalyst on a cordierite substrate. After coating, the carrier plus the inner and middle layers were dried, and then calcined at a temperature of 550° C. for about 1 hour.

### Example 2A

### Comparative

A catalyst composite having a catalytic material was prepared using three layers: an inner layer, a middle layer, and an outer layer. The layered catalyst composite contained palladium and rhodium with a total precious metal loading of 85 g/ft³ and with a Pd/Rh ratio of 7.5/1. The substrate had a volume of 60.1 in³ (1.0 L), a cell density of 400 cells per square inch, and a wall thickness of approximately 100 μm (4 mil). The layers were prepared as follows:

### Inner Layer

The inner layer was prepared with the same components, amounts, and methods as the inner layer of Example 1A.

### Middle Layer

The middle layer was prepared with the same components, amounts, and methods as the middle layer of Example 1A.

### Outer Layer

The outer layer was prepared with the same final components, amounts, and methods as the outer layer of Example 1A, where palladium in the form of palladium nitrate was used (rather than palladium tetraamine nitrate).

### Example 2B

### Comparative

A catalyst composite having a catalytic material was prepared using three layers: an inner layer, a middle layer, and an outer layer. The layered catalyst composite contained palladium and rhodium with a total precious metal loading of 114 g/ft³ and with a Pd/Rh ratio of 108/8. The substrate had a volume of 42.5 in³ (0.7 L), a cell density of 600 cells per square inch, and a wall thickness of approximately 100 μm (4 mil). The layers were prepared as follows:

### Inner Layer

The components present in the inner layer were high surface area lanthanum-stabilized gamma alumina, a ceria-zirconia composite with 30% by weight ceria content, palladium, zirconium oxide, lanthanum oxide, strontium oxide, barium oxide, and a binder, at concentrations of approximately 32.2%, 53.7%, 1.3%, 2.7%, 2.7%, 2,7%, 2,7%, and 2.2%, respectively, based on the calcined weight of the catalyst. The total loading of the inner layer was 1.9 g/in³.

Palladium in the form of a palladium-nitrate solution was impregnated by planetary mixer (P-mixer) onto the stabilized alumina to form a wet powder while achieving incipient wetness. After the impregnation of the precious metal onto the support, the mixture was then mixed with the remaining ingredients in the form of composite solid or soluble salts to form an aqueous washcoat slurry, which was milled to a particle size of 90% less than 11 microns. The slurry was coated onto a cordierite carrier using deposition methods known in the art for depositing the catalyst on a cordierite substrate. After coating, the carrier plus the inner layer were dried and then calcined at a temperature of 550° C. for about 1 hour.

### Middle Layer

The components present in the middle layer were a high surface stabilized area lanthanum-zirconium-gamma alumina, a ceria-zirconia composite with 36% by weight ceria content, rhodium, zirconium oxide, and a binder, at concentrations of approximately 30.4%, 65.2%, 0.4%, 0.9, and 3.1%, respectively, based on the calcined weight of the catalyst. The total loading of the middle layer was 1.2 g/in³.

Rhodium in the form of rhodium nitrate solutions was diluted and impregnated onto the stabilized gamma alumina and the ceria-zirconia composite by planetary mixer with 62% and 38% partition, and the (P-mixer) to form a wet powder while achieving incipient wetness. An aqueous slurry was then formed, using an acid to reduce the pH to <4.5. The slurry was milled to a particle size of 90% less than 12 microns. The slurry was coated onto the cordierite carrier over the inner layer using deposition methods known in the art for depositing the catalyst on a cordierite substrate. After coating, the carrier plus the inner and middle layers were dried, and then calcined at a temperature of 550° C. for about 1 hour.

### Outer Layer

The components present in the outer layer were a lanthanum-neodymium promoted high surface area gamma alumina; a ceria-zirconia composite with 36% by weight ceria content, palladium, zirconium oxide, strontium oxide, barium oxide, and a binder, at concentrations of approximately 68.0%, 17.0%, 2.6%, 0.7%, 2.7%, 5.4%, and 3.4%, respectively, based on the calcined weight of the catalyst. The total loading of the outer layer was 1.5 g/in³.

Palladium in the form of palladium nitrate solutions was impregnated onto the ceria-zirconia composite and the above-identified gamma alumina by planetary mixer (P-mixer) to form a wet powder while achieving incipient wetness as follows. An amount of 5% of the palladium was impregnated onto the ceria-zirconia composite and an amount of 95% of the palladium was impregnated onto the gamma alumina. An aqueous slurry was then formed with the remaining components, using an acid to reduce the pH to <4.5. The slurry was milled to a particle size of 90% less than 12 microns. The slurry was coated onto the cordierite carrier over the inner layer using deposition methods known in the art for depositing the catalyst on a cordierite substrate. After coating, the carrier plus the inner and middle layers were dried, and then calcined at a temperature of 550° C. for about 1 hour.

### Example 3A

### Testing

The catalyst composites of Examples 1A and 2A were engine aged for 50 hours via fuel-cut-type aging with maximum bed temperature of 950° C. The catalyst composites were then tested on a 2,2 L vehicle according to FTP-75. In the following table, “MB THC” means mid-bed total hydrocarbons and “TP NMHC” means tailpipe non-methane hydrocarbons, both of which were reported as total FTP emissions. The time to T₅₀ (the temperature where conversion reached 50%) is also reported.

| | | | Time to Reach |
|---|---|---|---|
| | MB THC | TP NMHC | HC Light-Off |
| | (mg/mile) | (mg/mile) | T₅₀ (sec) |
| Example 1A | 87 | 66 | 12 |
| Example 2A | 100 | 86 | 22 |
| Comparative | | | |

Example 1A showed improved HC light-off timing as compared to Example 2A which resulted in fewer overall FTP HC emissions. This means the change from an incompatible salt relative to the alumina support (the palladium nitrate of Example 2) to a pH compatible salt (palladium tetraamine nitrate of Example 1A) improved palladium dispersion and stability and therefore HC emissions.

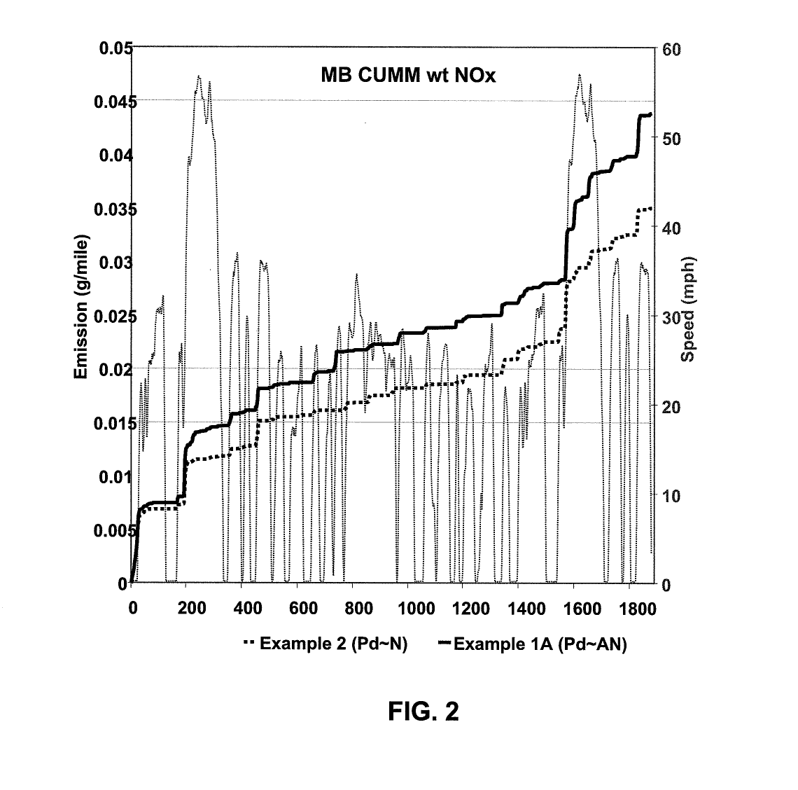

However, for NOx emissions with reference to FIG. 2, where “MB CUMM wt NOx” means mid-bed cumulative NOx emissions, Example 1A had higher NOx emissions (44 mg/mile) than Example 2A (35 mg/mile) for the period of the FTP testing. Further investigation showed that use of palladium tetraamine nitrate led to excessive palladium solubility in the washcoat slurries, meaning there was weak absorption by the palladium onto the alumina support in the outer layer. This means that the palladium tetraamine nitrate in the outer layer of Example 1A that was not chemically or thermally-fixed with the alumina support migrated to the Rh-containing layer below, thereby forming a Pd/Rh alloy which deactivated Rh for NOx performance. It was found that by thermally fixing the Pd to the alumina support, a well-dispersed, non-soluble, promoter-stabilized, chemically-bonded Pd/alumina support composite was formed, as provided in Example 1B, that improved NOx emissions as well as provided better HC and CO reduction according to the following table which shows overall FTP emissions. The thermal fixing of Pd substantially prevented the migration of Pd from the outer layer to the lower Rh layer, thereby retaining Rh activity in the lower layer and improving Pd effectiveness for HC diffusion purpose in the outer layer.

### Example 3B

### Testing

The catalyst composites of Examples 1B and 2B were engine aged for 100 hours via exothermic aging with maximum bed temperature of 965° C. The catalyst composites were then tested on a 2.85 L vehicle according to FTP-75.

It was found that by thermally fixing the Pd to the alumina support, a well-dispersed, non-soluble, promoter stabilized, chemically-bonded Pd/alumina support composite was formed, as provided in Example 1B, that improved NOx emissions as well as provided better HC and CO reduction according to the following table which shows overall FTP emissions. The thermal fixing of Pd substantially prevented the migration of Pd from the outer layer to the lower Rh layer, thereby retaining Rh activity in the lower layer and improving Pd effectiveness in the outer layer.

| | | CO/10 | NOx |
|---|---|---|---|
| | THC (mg/mile) | (mg/mile) | (mg/mile) |
| Example 1B | 39 | 48 | 25 |
| Example 2B | 48 | 57 | 42 |
| Comparative | | | |

### Example 4

Palladium-alumina powders were prepared by incipient wetness, where Example 4B used a compatible Pd source of palladium-tetraamine-nitrate on a barium-lanthana-neodymium alumina support, where Example 4C used a compatible Pd source of palladium-tetraamine-hydroxide, where Example 4D used a compatible Pd source of palladium-tetraamine-acetate, and where Example 4A (Comparative) used incompatible Pd source of palladium nitrate on the same support. This support had an average pore size of about 45 Å and BET surface area in the range of 140-190 m²/g. These washcoats were aged for 12 hrs at 1050° C. in air with 10% steam. Pd dispersion was then measured.

| | | Normalized Pd |
|---|---|---|
| Pd source | pH | dispersion index |
| Pd-nitrate | Acidic | 100 |
| Comparative Example 4A | | |
| Pd-tetraamine nitrate | Basic | 217 |
| Example 4B | | |
| Pd-tetraamine hydroxide | Basic | 192 |
| Example 4C | | |
| Pd-tetraamine acetate | Basic | 175 |
| Example 4D | | |

Where the Pd source was in the form of a basic salt, dispersion of the palladium was improved as compared to an acidic Pd source.

### Example 5

Palladium-alumina powders were prepared by incipient wetness, where Example 5B used a compatible Pd source of palladium-tetraamine-nitrate on a barium-lanthana-neodymium alumina support, and where Example 5A (Comparative) used incompatible palladium nitrate on the same support. This support had an average pore size of about 70 Å and BET surface area in the range of 150-180 m²/g. These washcoats were aged for 12 hrs at 1050° C. in air with 10% steam. Pd dispersion was then measured.

| | | Normalized Pd |
|---|---|---|
| Pd source | pH | dispersion index* |
| Pd-nitrate | Acidic | 217 |
| Example 5A (Comparative) | | |
| Pd-tetraamine nitrate | Basic | 367 |
| Example 5B | | |

*as compared to Example 4A

Where the Pd source was in the form of a pH compatible basic solution, specifically, the tetraamine nitrate solution of Example 5B, dispersion of the palladium was improved as compared to the acidic solution Pd source of Example 5A. XRD analysis of Pd in the outer layer of Example 5B showed a crystal size of <50 Å (±10%), whereas the same analysis for Example 5A showed a crystal size of 221 Å (±10%). Comparison of 5A with 4A shows that larger pore size improves dispersion. Comparison of Example 5B with 4A shows almost quadruple the dispersion where Example 5B has the combination of the use of a pH compatible salt with a larger pore size support.

### Example 6A

A catalyst composite having a catalytic material was prepared using three layers: an inner layer, a middle layer, and an outer layer. The layered catalyst composite contained palladium and rhodium with a total precious metal loading of 108 g/ft³ and with a Pd/Rh ratio of 101:7. The substrate had a volume of 53.4 in³ (0.875 L), a cell density of 600 cells per square inch, and a wall thickness of approximately 90 μm (3.5 mil). The layers were prepared as follows:

### Inner Layer

The components present in the inner layer were high surface area lanthanum-stabilized gamma alumina, a ceria-zirconia composite with 45% by weight ceria content, palladium, lanthanum oxide, and zirconium oxide, at concentrations of approximately 41.9%, 50.8%, 1.3%, 3.0%, and 3.0%, respectively, based on the calcined weight of the catalyst. The total loading of the inner layer was 1.7 g/in³.

Palladium in the form of a palladium tetraamine nitrate solution was impregnated by planetary mixer (P-mixer) onto the stabilized alumina to form a wet powder while achieving incipient wetness. An aqueous slurry was formed by combining water with all of the above components in solid or soluble salt forms, and milling to particle size of 90% less than 11 microns. The slurry was coated onto a cordierite carrier using deposition methods known in the art for depositing the catalyst on a cordierite substrate. After coating, the carrier plus the inner layer were dried and then calcined at a temperature of 550° C. for about 1 hour.

### Middle Layer

The components present in the middle layer were a high surface stabilized area lanthanum-zirconium-gamma alumina, a first ceria-zirconia composite with 40% by weight ceria content, a second ceria-zirconia composite with 5% by weight ceria content, rhodium, zirconium oxide, and an alumina binder, at concentrations of approximately 36.2%, 20.1%, 40.2%, 0.3%, 0.8%, and 2.4%, respectively, based on the calcined weight of the catalyst. The total loading of the middle layer was 1.2 g/in³

Rhodium in the form of rhodium nitrate solutions was impregnated onto the stabilized gamma alumina and both of the ceria-zirconia composites by planetary mixer (P-mixer) to form a wet powder while achieving incipient wetness. An amount of 50% of the rhodium was impregnated onto the ceria-zirconia composites and an amount of 50% of the palladium was impregnated onto the gamma alumina. An aqueous slurry was then formed, using an acid to reduce the pH to <4.5. The slurry was milled to a particle size of 90% less than 11 microns. The slurry was coated onto the cordierite carrier over the inner layer using deposition methods known in the art for depositing the catalyst on a cordierite substrate. After coating, the carrier plus the inner and middle layers were dried, and then calcined at a temperature of 450° C. for about 1 hour.

### Outer Layer

The components present in the outer layer were a lanthanum-neodymium-baria promoted high surface area gamma alumina; a ceria-zirconia composite with 40% by weight ceria content, palladium, zirconium oxide, strontium oxide, and a binder, at concentrations of approximately 74.1%, 19.8%, 2.6%, 0.7%, 0.7%, and 2.1%, respectively, based on the calcined weight of the catalyst. The total loading of the outer layer was 1.4 g/in³.

Palladium in the form of palladium nitrate solutions was impregnated onto the ceria-zirconia composite and the above-identified gamma alumina by planetary mixer (P-mixer) to form a wet powder while achieving incipient wetness as follows. An amount of 5% of the palladium was impregnated onto the ceria-zirconia composite and an amount of 95% of the palladium was impregnated onto the gamma alumina. An aqueous slurry was then formed with the remaining components, using an acid to reduce the pH to <4.5. The slurry was milled to a particle size of 90% less than 11 microns. The slurry was coated onto the cordierite carrier over the inner layer using deposition methods known in the art for depositing the catalyst on a cordierite substrate. After coating, the carrier plus the inner and middle layers were dried, and then calcined at a temperature of 550° C. for about 1 hour.

### Example 6B

### Comparative

A catalyst composite having a catalytic material was prepared in the same amounts and manner as Example 6A, with the exception of the use of palladium nitrate (rather than palladium-tetraamine-nitrate of Example 6A) in the inner layer.

### Example 7

### Testing

The catalyst composites of Examples 6A and 6B were engine aged for 50 hours via fuel-cut-type aging with maximum bed temperature of 950° C. The catalyst composites were then tested on a bench engine having a displacement and a space velocity of 100 K./hr. The temperature where conversion reached 50% (T₅₀) is reported.

| | HC | CO | NOx |
|---|---|---|---|
| | ° C. | ° C. | ° C. |
| Example 6A | 365 | 347 | 350 |
| Example 6B | 372 | 355 | 359 |
| Comparative | | | |

Where the Pd source was in the form of a basic salt (Example 6A), the catalyst composite showed a favorable decrease in the T₅₀ light-off temperature for HC, CO, and NOx as compared to the catalyst composite prepared using an acidic Pd source (Example 6B).

Reference throughout this specification to “one embodiment,” “certain embodiments,” “one or more embodiments” or “an embodiment” means that a particular feature, structure, material, or characteristic described in connection with the embodiment is included in at least one embodiment of the invention. Thus, the appearances of the phrases such as “in one or more embodiments,” “in certain embodiments,” “in one embodiment” or “in an embodiment” in various places throughout this specification are not necessarily referring to the same embodiment of the invention. Furthermore, the particular features, structures, materials, or characteristics may be combined in any suitable manner in one or more embodiments.

The invention has been described with specific reference to the embodiments and modifications thereto described above. Further modifications and alterations may occur to others upon reading and understanding the specification. It is intended to include all such modifications and alterations insofar as they come within the scope of the invention.

What is claimed is:

1. A method of making an emissions treatment catalyst, the method comprising:
providing a solution of a salt of a precious metal having a pH;
providing a promoted refractory metal oxide support having an aqueous slurry pH that is compatible with the pH of the solution of the salt of the precious metal;
impregnating the solution of the salt of the precious metal onto the promoted refractory metal oxide support to well disperse the precious metal and to form a wetted powder;
forming a washcoat slurry by mixing the wetted powder with water, binder, and a peptizing agent to form a mixture and by milling the mixture;
coating a carrier with the washcoat slurry to form a layer; and
drying and calcining the layer to form the emissions treatment catalyst.

2. The method of claim 1, further comprising thermal treating the wetted powder in an oven set at a temperature of at least 180° C. to thereby thermally fix the precious metal on the promoted support to form a supported precious metal composite.

3. The method of claim 2, wherein the oven is set at a temperature in the range of 350° C. to 550° C.

4. The method of claim 1, wherein the solution of the salt comprises a neutral or basic solution having a pH of 7 or greater, and thereby the promoted refractory metal oxide has an aqueous slurry pH of 7 or greater.

5. The method of claim 1, wherein the solution of the salt comprises an acidic solution having a pH of less than 7, and thereby the promoted refractory metal oxide has an aqueous slurry pH of less than 7.

6. The method of claim 1, wherein the precious metal is selected from the group consisting of palladium, platinum, and rhodium.

7. The method of claim 4, wherein the neutral or basic solution comprises a precious metal complex ion comprising an amine-based ligand with an anion selected from the group consisting of nitrate, hydroxide, and acetate.

8. The method of claim 7, wherein the amine-based ligand comprises a primary amine, a tetraamine, or a mixture of both.

9. The method of claim 1, wherein the refractory metal oxide support has been promoted by oxides of lanthanum, barium, zirconium, neodymium, yttrium, praseodymium, somarium, ceria, or combinations thereof.

10. The method of claim 4, wherein the solution comprises palladium tetraamine nitrate and optionally platinum tetraamine nitrate, and the promoted refractory metal oxide comprises baria-lanthana-alumina.

11. A catalyst composite for three-way conversion or diesel oxidation, the catalyst composite comprising: a layer of catalytic material on a carrier, the catalytic material comprising a precious metal component on a promoted refractory metal oxide support, the support comprising one or more promoters, wherein a precursor of the precious metal component has a solution pH that is compatible with an aqueous slurry pH of the support, the precious metal component is well-dispersed to provide intimate contact among the precious metal component and one or more promoters.

12. The catalyst composite of claim 11, wherein the precious metal component has a particle size of no more than 50 Å under fresh conditions or at calcination at a temperature of 530° C. or less.

13. The catalyst composite of claim 11, wherein the precious metal component and the promoted support are thermally treated to form a supported precious metal composite.

14. The catalyst composite of claim 11, wherein the refractory metal oxide support has an average pore radius of at least 45 Å.

15. The catalyst composite of claim 11, wherein the refractory metal oxide support has a BET surface area in the range of 140-190 m²/g.

16. The catalyst composite of claim 11, wherein the refractory metal oxide support has been promoted by an oxide of lanthanum, barium, zirconium, neodymium, yttrium, praseodymium, samarium, or combinations thereof.

17. The catalyst composite of claim 11, wherein the precursor of the precious metal component comprises palladium nitrate and optionally platinum nitrate, and the promoted refractory metal oxide comprises silica-alumina, silica-zirconia, silica-titania, zirconia-alumina, zirconia-titania, titania alumia, silica-zirconia alumina, silica-zirconia-titania, silica titania alumina, or combinations thereof.

18. The catalyst composite of claim 13, wherein the catalytic material comprises a first layer located under an outer layer, the first layer comprising a precious metal component selected from a rhodium component and optionally a platinum on a support, and wherein the outer layer comprises a precious metal component selected from a palladium component and optionally a platinum component, wherein the palladium component and the optional platinum component in the outer layer are formed by the use of a basic precious metal solution formed from a complex ion comprising tetraamine nitrate, tetraamine hydroxide, tetraamine acetate, a primary amine nitrate, a primary amine hydroxide, a primary amine acetate, or combinations thereof.

19. The catalyst composite of claim 13, wherein the catalytic material is more thermally stable as compared to a comparative catalytic material having a palladium component in an outer layer that is not dispersed to provide intimate contact among the palladium component and the one or more promoters.

20. A method of treating an emissions stream from an engine, the method comprising contacting the emissions stream with a catalytic material on a carrier, the catalytic material comprising a first layer located under an outer layer, the first layer comprising a precious metal component selected from a rhodium component and an optional platinum on a support, the outer layer comprises a precious metal component selected from a palladium component and an optional platinum on a support promoted oxides of lanthanum, barium, zirconium, neodymium, or combinations thereof, wherein the palladium component in the outer layer is formed by the use of thermally treated powders of a basic palladium solution formed from a complex ion comprising tetraamine nitrate, tetraamine hydroxide, tetraamine acetate, or combinations thereof.
